(19) United States
(12) Patent Application Publication
(10) Pub. No.: US 2018/0157121 A1
(43) Pub. Date: Jun. 7, 2018

(54) INFORMATION PROCESSING APPARATUS, DISPLAY APPARATUS, AND INFORMATION PROCESSING METHOD

(71) Applicant: CANON KABUSHIKI KAISHA, Tokyo (JP)

(72) Inventors: Yasuhiro Matsuura, Yokohama-shi (JP); Mitsuru Tada, Machida-shi (JP)

(21) Appl. No.: 15/825,776

(22) Filed: Nov. 29, 2017

(30) Foreign Application Priority Data
Dec. 7, 2016 (JP) 2016-237330

(51) Int. Cl. G02F 1/1335

(52) U.S. Cl. CPC G02F 1/133611; H05B 33/0827; G02F 1/133603

(57) ABSTRACT

An information processing apparatus acquires first profile data related to a first distribution; acquires second profile data related to a second distribution; and generates, based on a third light emission pattern that is different from the first light emission pattern and the second light emission pattern and is based on input image data of a display apparatus, the first profile data, and the second profile data, a correction parameter for correcting at least one of the input image data and the third light emission pattern.

### BACKGROUND OF THE INVENTION

### Field of the Invention

The present invention relates to an information processing apparatus, a display apparatus, and an information processing method.

### Description of the Related Art

Conventionally, a cold-cathode fluorescent lamp (CCFL) has been used as a light source of a backlight apparatus for a liquid crystal display apparatus. However, in recent years, the number of backlight apparatuses each using a light-emitting diode (LED) as the light source is increasing. Since the LED is a point light source, in the case where the LED is used as the light source of the backlight apparatus, it is necessary to suppress the occurrence of unevenness of light (brightness unevenness, color unevenness, or the like) emitted from the backlight apparatus by modifying the arrangement of the LEDs, the diffusion structure of light, and the reflection structure of light. The above unevenness easily occurs particularly in the backlight apparatus that uses a plurality of the LEDs having mutually different luminescent colors, and hence the above modification is required. As the plurality of the LEDs having mutually different luminescent colors, for example, an R-LED that emits red light, a G-LED that emits green light, and a B-LED that emits blue light are used.

In addition, there is proposed a light-emitting apparatus that has the B-LED and a wavelength conversion member having an R phosphor and a G phosphor. The R phosphor is a phosphor that emits red light by excitation caused by blue light. The G phosphor is a phosphor that emits green light by excitation caused by blue light. In the above light-emitting apparatus, part of the blue light from the B-LED is converted into red light by the R phosphor, and the red light is emitted from the wavelength conversion member. In addition, part of the blue light from the B-LED is converted into green light by the G phosphor, and the green light is emitted from the wavelength conversion member. Further, part of the blue light from the B-LED is emitted from the wavelength conversion member without being converted (passes therethrough). As a result, combination light in which the blue light, the red light, and the green light are combined is emitted from the light-emitting apparatus, and hence it is possible to obtain light having a wide color gamut as the light from the light-emitting apparatus.

In recent years, a quantum dot is proposed as a phosphor (wavelength conversion element) capable of generating high-purity light by generating excitation. The quantum dot is a phosphor that reacts with ultraviolet light, blue light, or the like to emit light corresponding to the particle diameter of the quantum dot. When the quantum dot is used, it is possible to obtain light having a half-width of about 40 nm (red light, green light, or the like) from blue light, and hence it is possible to obtain light having a wider color gamut as the light emitted from the light-emitting apparatus. The light-emitting apparatus that uses the quantum dot is disclosed in, e.g., Japanese Patent Application Publication No. 2012-022028. In a technique disclosed in Japanese Patent Application Publication No. 2012-022028, a sheet-like member (quantum dot sheet) containing the quantum dot is used as the wavelength conversion member.

In addition, as a technique related to the backlight apparatus, there is proposed a technique for individually controlling light emission brightnesses of a plurality of LEDs. By individually controlling the light emission brightnesses of the plurality of the LEDs, it is possible to partially change the light emission brightness of the backlight apparatus. Such control is referred to as “local dimming control”. For example, in the local dimming control, the contrast of a display image is enhanced by performing a process for analyzing the brightness value of image data and controlling the light emission brightness of the LED based on the result of the brightness value analysis for each of a plurality of divided display areas that constitute a screen.

A technique related to the local dimming control is disclosed in, e.g., Japanese Patent Application Publication No. 2009-251570. In the technique disclosed in Japanese Patent Application Publication No. 2009-251570, the backlight apparatus is constituted by a plurality of blocks, and the average brightness of the backlight apparatus based on a target block and a peripheral block is calculated by using predetermined profile data. The predetermined profile data shows the distribution of light that is emitted from one block (light source) and is then emitted from the backlight apparatus. By subtracting the brightness of the target block from the average brightness, the degree of an influence of the peripheral block exerted on the target block is calculated. Thereafter, based on a difference between the required brightness of the target block based on image data and the degree of the influence described above (subtraction result), the light emission brightness of the target block is calculated.

### SUMMARY OF THE INVENTION

Every time light from the LED is reflected by an optical member, the wavelength conversion member, or the like, spectral characteristics of the light from the LED change. In addition, every time the light from the LED passes through the optical member, the wavelength conversion member, or the like, the spectral characteristics of the light from the LED change. Examples of the optical member include a reflection plate, a reflection sheet, a diffusion plate, a diffusion sheet, a brightness enhancement film (BEF), and a dual brightness enhancement film (DBEF). In the case where the wavelength conversion member having the quantum dot is used in the light-emitting apparatus, the spectral characteristics of the light from the LED change in accordance with the distance of passage of the light from the LED through the wavelength conversion member and the number of times that the light from the LED impinges on the quantum dot. Herein, consideration is given to the case where the wavelength conversion member has the quantum dot that coverts blue light into green light and the quantum dot that coverts blue light into red light. In this case, the color of the light emitted from the light-emitting apparatus becomes close to yellow due to an increase in the number of times that the blue light from the B-LED impinges on the quantum dot. For example, in the case of light (leakage light) that is leaked from the B-LED corresponding to a given divided display area into another divided display area, the distance of passage of the blue light from the B-LED through the wavelength conversion member is long, and the number of times that the blue light from the B-LED impinges on the quantum dot is large. Accordingly, the color of the light emitted from the light-emitting apparatus is caused to become close to yellow by the leakage light. The color of the light emitted from the light-emitting apparatus becomes close to yellow, and the brightness of the light emitted from the light-emitting apparatus is thereby increased.

Due to various factors including the change of the spectral characteristics described above, the shape of the distribution of light that is emitted from the light source and is then emitted from the light-emitting apparatus changes depending on a light emission pattern of the light-emitting apparatus. However, in the technique disclosed in Japanese Patent Application Publication No. 2009-251570, since the profile data is fixed, as a process parameter that is used in a process based on the distribution of the light emitted from the light-emitting apparatus, it is not possible to obtain a process parameter that realizes a high-accuracy process. Accordingly, it is not possible to realize the high-accuracy process as the process based on the distribution of the light emitted from the light-emitting apparatus.

The present invention in its first aspect provides an information processing apparatus comprising:

at least one processor; and

at least one memory storing a program which, when executed by the at least one processor, causes the information processing apparatus to

acquire first profile data related to a first distribution that is a distribution of light emitted from a light-emitting unit of a display apparatus in a first light emission pattern in which one light source unit that is one of a plurality of light source units of the light-emitting unit emits light;

acquire second profile data related to a second distribution that is a distribution of light emitted from the light-emitting unit in a second light emission pattern in which two or more peripheral light source units that are present in a periphery of the one light source unit emit light; and

generate, based on a third light emission pattern that is different from the first light emission pattern and the second light emission pattern and is based on input image data of the display apparatus, the first profile data, and the second profile data, a correction parameter for correcting at least one of the input image data and the third light emission pattern.

The present invention in its second aspect provides a display apparatus comprising the above mentioned information processing apparatus.

The present invention in its third aspect provides an information processing method comprising:

acquiring first profile data related to a first distribution that is a distribution of light emitted from a light-emitting unit of a display apparatus in a first light emission pattern in which one light source unit that is one of a plurality of light source units of the light-emitting unit emits light;

acquiring second profile data related to a second distribution that is a distribution of light emitted from the light-emitting unit in a second light emission pattern in which two or more peripheral light source units that are present in a periphery of the one light source unit emit light; and

generating, based on a third light emission pattern that is different from the first light emission pattern and the second light emission pattern and is based on input image data of the display apparatus, the first profile data, and the second profile data, a correction parameter for correcting at least one of the input image data and the third light emission pattern.

The present invention in its fourth aspect provides a non-transitory computer readable medium that stores a program, wherein

the program causes a computer to execute:

acquiring first profile data related to a first distribution that is a distribution of light emitted from a light-emitting unit of a display apparatus in a first light emission pattern in which one light source unit that is one of a plurality of light source units of the light-emitting unit emits light;

acquiring second profile data related to a second distribution that is a distribution of light emitted from the light-emitting unit in a second light emission pattern in which two or more peripheral light source units that are present in a periphery of the one light source unit emit light; and

generating, based on a third light emission pattern that is different from the first light emission pattern and the second light emission pattern and is based on input image data of the display apparatus, the first profile data, and the second profile data, a correction parameter for correcting at least one of the input image data and the third light emission pattern.

Further features of the present invention will become apparent from the following description of exemplary embodiments with reference to the attached drawings.

### BRIEF DESCRIPTION OF THE DRAWINGS

FIG. 1 shows an example of the configuration of a display apparatus according to Embodiment 1;

FIGS. 2A to 2C show an example of light emitted from a light-emitting unit according to Embodiment 1;

FIGS. 3A to 3C show an example of the light emitted from the light-emitting unit according to Embodiment 1;

FIG. 4 shows an example of divided display areas according to Embodiment 1;

FIG. 5 shows an example of single light emission profile data according to Embodiment 1;

FIG. 6 shows an example of a measured reference peripheral light emission distribution according to Embodiment 1;

FIG. 7 shows an example of an estimated reference peripheral light emission distribution according to Embodiment 1;

FIG. 8 shows an example of peripheral light emission profile data according to Embodiment 1;

FIG. 9 shows an example of the distribution of a light emission control value according to Embodiment 1;

FIG. 10 shows an example of the distribution of an influence degree according to Embodiment 1;

FIG. 11 shows an example of an estimation method of a display light emission distribution according to Embodiment 1; and

FIG. 12 shows an example of the configuration of a display apparatus according to Embodiment 2.

### DESCRIPTION OF THE EMBODIMENTS

### Embodiment 1

Hereinbelow, Embodiment 1 of the present invention will be described. In the following description, a description will be given of an example in which a display apparatus that displays an image on a screen by modulating light emitted from a light-emitting unit (light-emitting apparatus) has an information processing apparatus according to the present embodiment.

However, the information processing apparatus may also be an apparatus separate from the display apparatus. For example, the information processing apparatus may be a personal computer (PC) separate from the display apparatus. The information processing apparatus generates a correction parameter for correcting at least one of input image data of the display apparatus and a light emission pattern of the light-emitting unit.

In addition, the display apparatus may be any apparatus as long as the apparatus displays the image on the screen by modulating the light emitted from the light-emitting unit. For example, the display apparatus may be a transmission-type liquid crystal display apparatus, a reflection-type liquid crystal display apparatus, or the like. The display apparatus may also be a MEMS shutter display apparatus that uses a micro electro mechanical system (MEMS) shutter instead of a liquid crystal element.

The display apparatus may be an advertisement display apparatus, a sign display apparatus, or the like. The display apparatus may be a color display apparatus (a display apparatus capable of displaying a color image) or may also be a monochrome display apparatus (a display apparatus capable of displaying only a monochrome image).

Problem

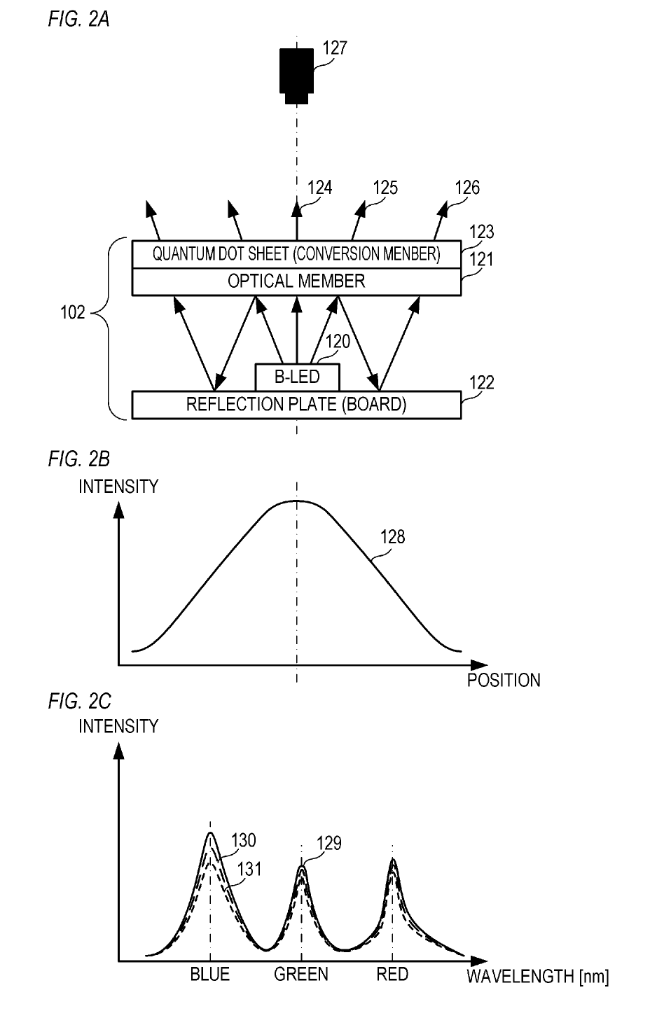

A description will be given of a specific example of the problem to be solved in the present embodiment. FIG. 2A shows an example of the cross section of a light-emitting unit 102 according to the present embodiment. The light-emitting unit 102 has a plurality of light source units and a conversion member (wavelength conversion member). The conversion member converts the wavelength of light emitted from the plurality of the light source units.

FIG. 2A shows, as one light source unit, one B-LED 120 that is a light-emitting diode (LED) that emits blue light. The B-LED 120 is provided on a reflection plate (board) 122. As the conversion member, a quantum dot sheet 123 is shown. The quantum dot sheet 123 is a sheet-like member that contains a plurality of R quantum dots and a plurality of G quantum dots. The R quantum dot is a quantum dot that emits red light by excitation caused by blue light. The G quantum dot is a quantum dot that emits green light by excitation caused by blue light.

In the light-emitting unit 102, part of the blue light emitted from the B-LED 120 is converted into red light by the R quantum dot, and the red light is emitted from the quantum dot sheet 123. In addition, part of the blue light emitted from the B-LED 120 is converted into green light by the G quantum dot, and the green light is emitted from the quantum dot sheet 123. Further, part of the blue light emitted from the B-LED 120 is emitted from the quantum dot sheet 123 without being converted.

In the example in FIG. 2A, an optical member 121 is provided between the B-LED 120 and the quantum dot sheet 123, and the blue light emitted from the B-LED 120 becomes incident on the quantum dot sheet 123 via the optical member 121. The optical member 121 gives an optical change to the incident light, and emits the light to which the optical change has been given. Examples of the optical member 121 include a diffusion plate, a diffusion sheet, a brightness enhancement film (BEF), and a dual brightness enhancement film (DBEF).

When light is emitted from the light-emitting unit 102, light from the B-LED 120 is reflected by the reflection plate 122, the quantum dot sheet 123, and the optical member 121, and passes through the quantum dot sheet 123 and the optical member 121. However, reflection characteristics of the reflection plate 122, the quantum dot sheet 123, and the optical member 121 and transmission characteristics of the quantum dot sheet 123 and the optical member 121 are not uniform over the entire frequency band of light. Accordingly, spectral characteristics of the light from the B-LED 120 change every time the light is reflected thereby, and change every time the light passes therethrough. In particular, the spectral characteristics of the light from the B-LED 120 significantly change in the quantum dot sheet 123. The magnitude of the change of the spectral characteristics in the quantum dot sheet 123 changes depending on the distance of the passage of the light from the B-LED 120 through the quantum dot sheet 123 (passage distance) and the number of times that the light from the B-LED 120 impinges on the quantum dot (the number of times of the impingement).

FIG. 2A shows the state of diffusion of the light emitted from the B-LED 120. Lights 124, 125, and 126 are lights emitted from the B-LED 120 and then emitted from the quantum dot sheet 123. The light 124 is light that has been emitted immediately upward from the B-LED 120 and has passed through the optical member 121 and the quantum dot sheet 123. The light 125 is light that has been emitted obliquely from the B-LED 120 and has passed through the optical member 121 and the quantum dot sheet 123. The light 126 is light that has been emitted obliquely from the B-LED 120, has been reflected by the optical member 121 and the reflection plate 122, and has passed through the optical member 121 and the quantum dot sheet 123.

FIG. 2B shows an example of an intensity (brightness) distribution 128 of light emitted from the light-emitting unit 102 in a state in which only B-LED 120 is turned on. The intensity distribution 128 is obtained from, e.g., the result of shooting of a camera 127 provided at a position immediately above the B-LED 120. The horizontal axis in FIG. 2B indicates a position in a direction parallel to a light-emitting surface of the light-emitting unit 102. The vertical axis in FIG. 2B indicates the intensity (brightness) of light. The light emitted from the B-LED 120 attenuates with distance from the B-LED 120. Accordingly, in the intensity distribution 128, the intensity of the light is reduced with distance from the B-LED 120.

FIG. 2C shows an example of the spectral characteristics of light emitted from the light-emitting unit 102. The horizontal axis in FIG. 2C indicates the wavelength of the light, and the vertical axis in FIG. 2C indicates the intensity of the light. Spectral characteristics (spectrum) 129 correspond to the light 124, spectral characteristics 130 correspond to the light 125, and spectral characteristics 131 correspond to the light 126. In the blue light emitted obliquely from the B-LED 120, the passage distance is longer and the number of times of the impingement is larger than those in the blue light emitted immediately upward from the B-LED 120. Accordingly, in the blue light emitted obliquely from the B-LED 120, the ratio of the blue light that is converted into the red light and the green light by the quantum dot sheet 123 is larger than that in the blue light emitted immediately upward from the B-LED 120. As a result, as shown in FIG. 2C, in the spectral characteristics 130 and 131, the intensity of the blue light is reduced and the color of the light emitted from the light-emitting unit 102 becomes close to yellow as compared with the spectral characteristics 129. The color of the light emitted from the light-emitting unit 102 becomes close to yellow, and the intensity of the light emitted from the light-emitting unit 102 is thereby increased.

When the blue light that has been emitted from the B-LED 120 and has passed through the quantum dot sheet 123 is reflected to the side of the quantum dot sheet 123, it follows that the blue light emitted from the B-LED 120 passes through the quantum dot sheet 123 a plurality of times. Part of the blue light is converted into the red light and the green light every time the blue light from the B-LED 120 passes through the quantum dot sheet 123. Accordingly, by an increase in the number of times that the blue light from the B-LED 120 passes through the quantum dot sheet 123 (the number of times of the passage), the color of the light emitted from the light-emitting unit 102 is caused to become close to yellow. Further, light obtained by the quantum dot (the red light, the green light, or the like) is diffused from the quantum dot in various directions. With this, the red light and the green light included in the light emitted from the light-emitting unit 102 are increased, and hence the color of the light emitted from the light-emitting unit 102 is caused to become close to yellow.

In the light-emitting unit 102, due to various factors, the shape of the distribution of light that is emitted from (one) B-LED and is then emitted from the light-emitting unit 102 changes depending on the light emission pattern of the light-emitting unit 102. The various factors mentioned above include the change of the spectral characteristics described above.

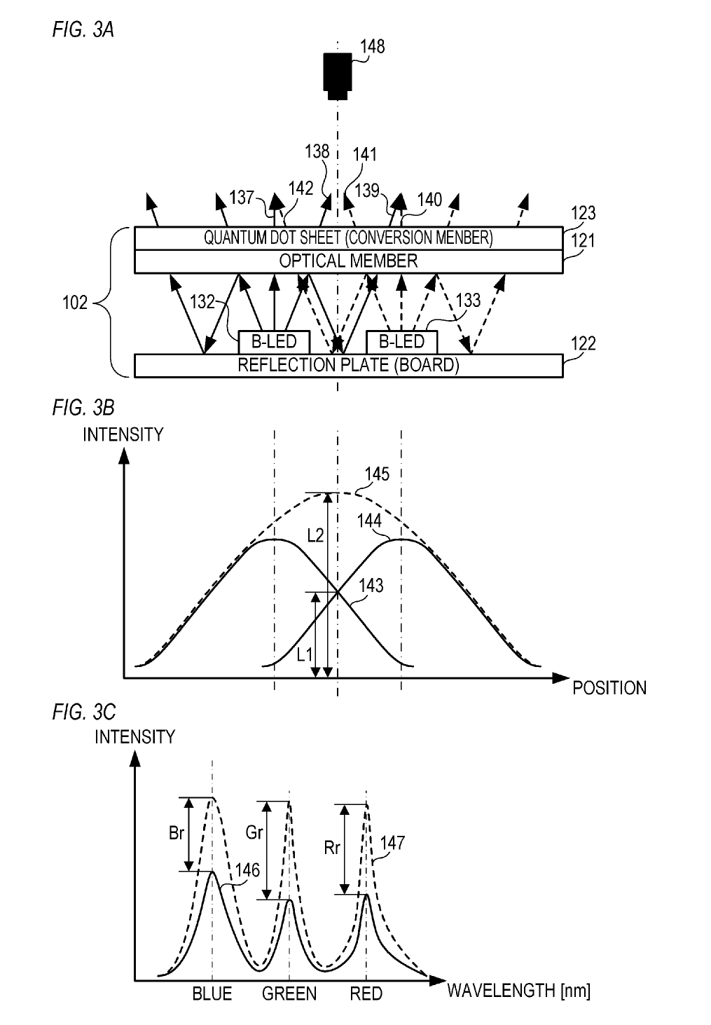

FIG. 3A shows an example of the cross section of the light-emitting unit 102. FIG. 3A shows two B-LEDs 132 and 133 that are two light source units. FIG. 3A shows the state of diffusion of lights emitted from the B-LEDs 132 and 133. Lights 137, 138, and 139 are lights that are emitted from the B-LED 132 and are then emitted from the quantum dot sheet 123. Lights 140, 141, and 142 are lights that are emitted from the B-LED 133 and are then emitted from the quantum dot sheet 123.

FIG. 3B shows an example of the intensity distribution of light emitted from the light-emitting unit 102. An intensity distribution 143 is the intensity distribution of the light emitted from the light-emitting unit 102 in a state in which only the B-LED 132 is turned on, and an intensity distribution 144 is the intensity distribution of the light emitted from the light-emitting unit 102 in a state in which only the B-LED 133 is turned on. An intensity distribution 145 is the intensity distribution of the light emitted from the light-emitting unit 102 in a state in which only the B-LEDs 132 and 133 are turned on. The intensity distributions 143 to 145 are obtained from, e.g., the result of shooting of a camera 148 provided so as to oppose a middle position between the B-LED 132 and the B-LED 133. From FIG. 3B, it can be seen that, in the intensity distribution 145, an intensity L2 at the above middle position is higher than the sum of an intensity L1 of the intensity distribution 143 and an intensity L1 of the intensity distribution 144 (2×L1).

The presence of the phenomenon shown in FIG. 3B can be interpreted as the “presence of the change of the shape of the brightness distribution of the light emitted from the B-LED and then emitted from the light-emitting unit 102 that depends on the light emission pattern of the light-emitting unit 102”. The increase in the ratio of the green light and the red light included in the light from the light-emitting unit 102 by the light having the long passage distance and the light having a large number of times of the passage (e.g., the lights 138, 141, 139, and 142) can be mentioned as one of the causes of the above phenomenon. Due to the similar causes, the shape of the color distribution of the light emitted from the B-LED and then emitted from the light-emitting unit 102 also changes depending on the light emission pattern of the light-emitting unit 102.

FIG. 3C shows an example of the spectral characteristics of the light emitted from the light-emitting unit 102. Spectral characteristics 146 and 147 correspond to the above middle position. The spectral characteristics 146 correspond to the state in which only the B-LED 132 is turned on, and the spectral characteristics 147 correspond to the state in which only the B-LEDs 132 and 133 are turned on. In an increase from the intensity of the spectral characteristics 146 to the intensity of the spectral characteristics 147, an increase Gr in the intensity of the green light and an increase Rr in the intensity of the red light are larger than an increase Br in the intensity of the blue light. This increase in intensity can also be interpreted as the “increase in the ratio of the green light and the red light included in the light from the light-emitting unit 102 by the light having the long passage distance and the light having a large number of times of the passage”. Accordingly, the increase in the ratio of the green light and the red light included in the light from the light-emitting unit 102 by the light having the long passage distance and the light having a large number of times of the passage can be mentioned as one of the causes of the above phenomenon.

Herein, there are cases where light emission intensities (light emission brightnesses) of a plurality of the B-LEDs are individually controlled. Such control is referred to as “local dimming control”. In addition, there are cases where various processes are performed based on the distribution of the light emitted from the light-emitting unit 102. For example, there are cases where processes for suppressing brightness deviation of the light from the light-emitting unit 102, color shift of the light from the light-emitting unit 102, brightness unevenness of a display image (an image displayed on a screen), color unevenness of the display image, brightness deviation of the display image, and color shift of the display image are performed.

As a conventional process method based on the distribution of the light emitted from the light-emitting unit 102, there is a method in which the intensity distribution of the light emitted from each B-LED is assumed to have the same shape as that of the intensity distribution 128 in FIG. 2B. However, in such a method, the above change of the shape of the distribution is not considered, and hence it is not possible to realize a high-accuracy process. The above change of the shape of the distribution is not considered also in the other conventional process methods, and hence it is not possible to realize the high-accuracy process.

Note that the configuration of the light-emitting unit (light-emitting apparatus) is not limited to the above configuration. For example, one light source unit may have a plurality of light-emitting elements. The light-emitting element is not limited to the LED. For example, as the light-emitting element, an organic EL element, a semiconductor laser, a plasma element, or a cold-cathode fluorescent lamp (CCFL) may also be used. Conversion characteristics of the conversion member (the wavelength before the conversion, the wavelength after the conversion, and the like) are not particularly limited. The light (predetermined light) of which the wavelength is converted by the conversion member is not limited to the blue light. For example, the predetermined light may be ultraviolet light (including near ultraviolet light). Both of the blue light and the ultraviolet light may be used as the predetermined light. That is, each of the plurality of the light source units may have at least one or more light-emitting elements that emit the blue light or one or more light-emitting elements that emit the ultraviolet light as one or more light-emitting elements that emit the predetermined light. Light that includes light other than the blue light and the ultraviolet light may be emitted from the light source unit. For example, each of the plurality of the light source units may have one or more light-emitting elements that emit white light. Each of the plurality of the light source units may have a plurality of the light-emitting elements having mutually different luminescent colors. The conversion member may have a phosphor different from the quantum dot.

In the case where the shape of the distribution of the light that is emitted from (one) light source unit and is then emitted from the light-emitting unit changes depending on the light emission pattern of the light-emitting unit, the above problem occurs irrespective of the type of the light-emitting unit. For example, in the case where the shape of the distribution of the light that is emitted from the light source unit and is then emitted from the light-emitting unit changes depending on the light emission pattern of the light-emitting unit, the above problem occurs even in the light-emitting unit without the conversion member.

Configuration of Display Apparatus

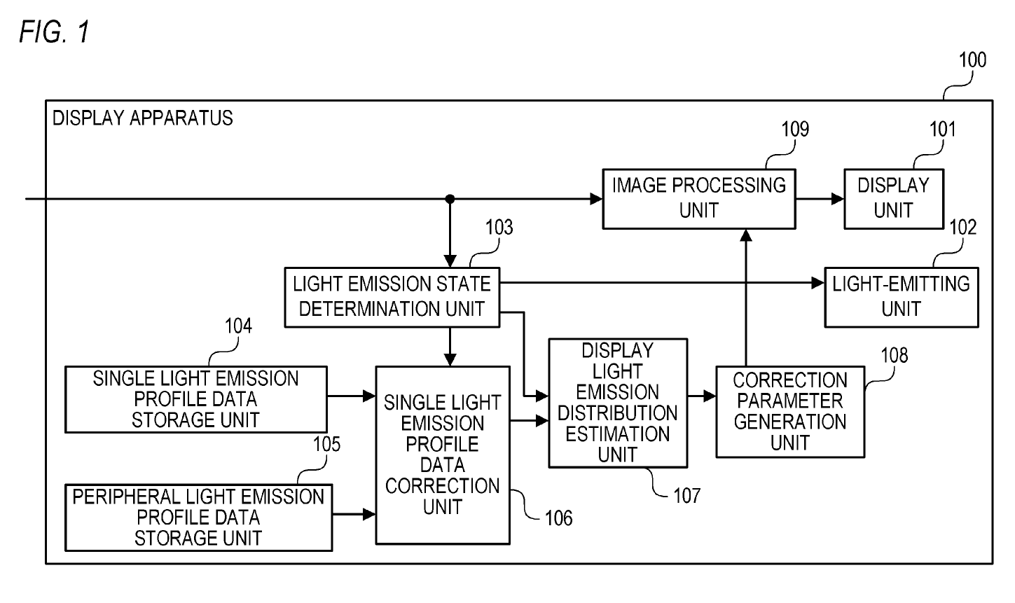

A description will be given of an example of the configuration of the display apparatus according to the present embodiment. FIG. 1 shows an example of the configuration of a display apparatus 100 according to the present embodiment. The display apparatus 100 has a display unit 101, the light-emitting unit 102, a light emission state determination unit 103, a single light emission profile data storage unit 104, and a peripheral light emission profile data storage unit 105. In addition, the display apparatus 100 has a single light emission profile data correction unit 106, a display light emission distribution estimation unit 107, a correction parameter generation unit 108, and an image processing unit 109.

The display unit 101 displays an image by modulating (passing, reflecting, and the like) light emitted from the light-emitting unit 102 based on input image data. In the present embodiment, display image data is generated from the input image data by the image processing unit 109. The display unit 101 displays the image by modulating the light from the light-emitting unit 102 in accordance with the display image data outputted from the image processing unit 109. The display unit 101 is, e.g., a liquid crystal panel.

The light-emitting unit 102 emits light to the display unit 101. As described above, the light-emitting unit 102 has a plurality of the light source units. In the present embodiment, a plurality of divided display areas constituting the area of the screen are associated with the plurality of the light source units respectively as a plurality of light emission control areas for controlling light emission states (light emission brightnesses, luminescent colors, and the like) of the light source units. The plurality of the divided display areas are used also as a plurality of estimation areas (partial areas) for obtaining information indicative of the distribution of the light emitted from the light-emitting unit 102. In a transmission-type liquid crystal display apparatus or the like, the light-emitting unit 102 is referred to as a “backlight apparatus”, a “backlight unit”, or the like.

Note that the light emission control area is not limited to the divided display area. For example, the light emission control area may be positioned away from the other light emission control areas, and at least part of the light emission control area may overlap at least part of another light emission control area. Two or more light source units may be associated with one light emission control area. The light emission control area may be part of the area of the screen and may also be the entire area of the screen.

In addition, the estimation area is not limited to the divided display area. For example, the estimation area may be an area of part of the light-emitting surface of the light-emitting unit 102. The estimation area may be positioned away from the other estimation areas. Two or more estimation areas may be associated with one light source unit.

In the present embodiment, the light emission state of each light source unit is controlled in accordance with a light emission control value bd outputted from the light emission state determination unit 103. Specifically, the light emission control value bd corresponds to the light emission brightness (light emission intensity) of the light source unit. The light emission brightness of the light source unit is controlled in accordance with the light emission control value bd. Note that the light source unit may have a configuration capable of changing the luminescent color. The luminescent color of the light source unit may be controlled in accordance with the light emission control value bd. One of the light emission brightness of the light source unit and the luminescent color of the light source unit may be controlled in accordance with the light emission control value bd. Both of the light emission brightness of the light source unit and the luminescent color of the light source unit may be controlled in accordance with the light emission control value bd.

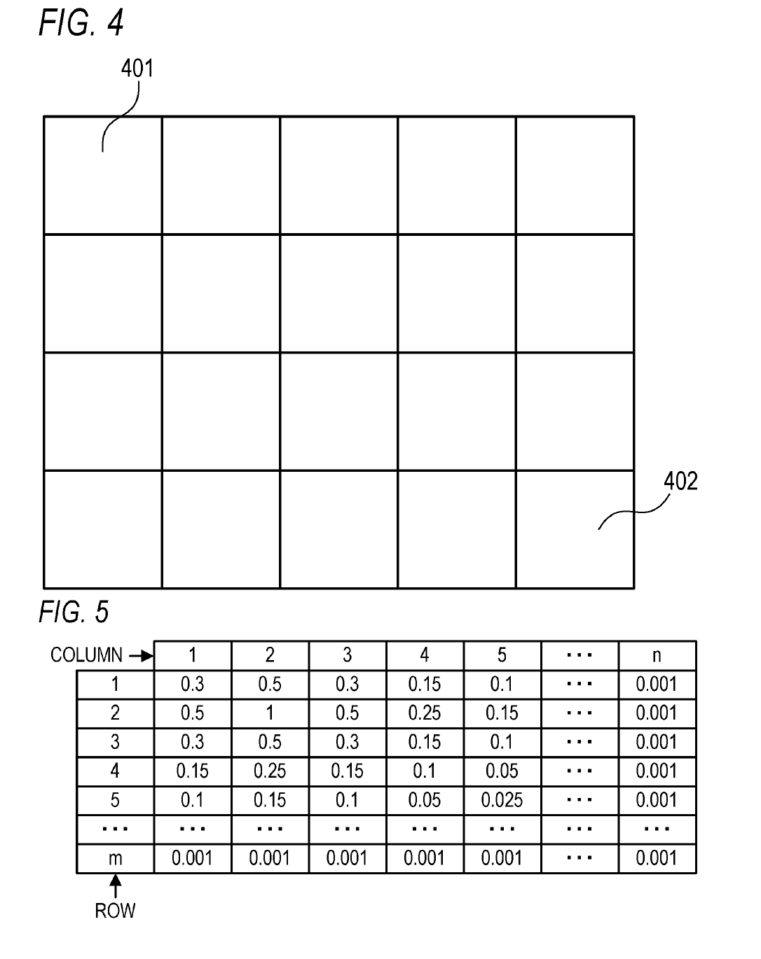

In the present embodiment, the plurality of the divided display areas are arranged in a matrix form. FIG. 4 is a schematic view showing an example of the plurality of the divided display areas. In the example in FIG. 4, the screen is constituted by 20 divided display areas arranged in 4 rows and 5 columns. In the present embodiment, the light emission control value bd of the light source unit corresponding to the divided display area in the m-th row and the n-th column is described as a “light emission control value bdmn”. For example, the light emission control value bd of the light source unit corresponding to a divided display area 401 in the first row and the first column is a light emission control value bd11, and the light emission control value bd of the light source unit corresponding to a divided display area 402 in the fourth row and the fifth column is a light emission control value bd45.

Note that the arrangement of the light source units, the number of the light source units, the arrangement of the divided display areas, and the number of the divided display areas are not particularly limited. For example, the plurality of the divided display areas may be disposed in a staggered arrangement. The number of the divided display areas may be more than or less than 20. The plurality of the light source units may be disposed in a staggered arrangement. The number of the light source units may be more than or less than 20.

The light emission state determination unit 103 individually determines the light emission control values bd of the plurality of the light source units based on the input image data. In the present embodiment, the light emission state determination unit 103 determines, for each of the plurality of the divided display areas, the light emission control value bd for controlling the light emission brightness of the light source unit corresponding to the divided display area based on the input image data in the divided display area. Subsequently, the light emission state determination unit 103 outputs a plurality of the light emission control values bd corresponding to the plurality of the light source units respectively to the light-emitting unit 102. With this, the light emission states of the plurality of the light source units are individually controlled. The light emission state determination unit 103 outputs the plurality of the light emission control values bd also to the single light emission profile data correction unit 106 and the display light emission distribution estimation unit 107.

Determination Method of Light Emission Control Value bd

A description will be given of a specific example of a determination method of the light emission control value bd according to the present embodiment.

Step 1-1

First, the light emission state determination unit 103 converts each pixel value of the input image data to a brightness value Y. For example, in the case where the pixel value of the input image data has RGB values (R value, G value, B value)=(R, G, B), the light emission state determination unit 103 calculates the brightness value Y by using the following Expression 1. In Expression 1, “α”, “β”, and “γ” are predetermined coefficients (brightness conversion coefficients) for converting the RGB values to the Y value.

Y=α×R+β×G+γ×B Expression 1

Step 1-2

Next, the light emission state determination unit 103 calculates, for each of the plurality of the divided display areas, an average value (average brightness value) Yav of a plurality of the brightness values Y in the divided display area. In the present embodiment, the average brightness value Yav corresponding to the divided display area in the m-th row and the n-th column is described as an “average brightness value Yavmn”.

Step 1-3

Subsequently, the light emission state determination unit 103 determines, for each of the plurality of the divided display areas, the light emission control value bd of the light source unit corresponding to the divided display area in accordance with the average brightness value Yav corresponding to the divided display area. In the present embodiment, the light emission state determination unit 103 calculates the light emission control value bdmn by using the following Expression 2. In Expression 2, “Ymax” is the upper limit value of the brightness value Y. In the present embodiment, the light emission control value bd is a value of 0 to 1, and the value is larger as the light emission brightness is higher.

bdmn=Yavmn÷Ymax Expression 2

Note that the light emission control value bd is not limited to the above value. For example, the range of the light emission control value bd may be wider or narrower than the range of 0 to 1. The light emission control value bd may be smaller as the light emission brightness is higher. In addition, the determination method of the light emission control value bd is not limited to the above method. For example, the light emission control value bd may be determined by using the other characteristic values of the input image data. As the other characteristic values, it is possible to use the maximum value of the brightness value Y, the minimum value of the brightness value Y, the mean value of the brightness value Y, the mode of the brightness value Y, and the histogram of the brightness value Y. Each of the average value, the maximum value, the minimum value, the mean value, or the mode can be interpreted as a “representative value”. As the other characteristic values, it is also possible to use the representative value of the pixel value (or a gradation value) different from the brightness value Y, and the histogram of the pixel value different from the brightness value Y. As the determination method of the light emission control value bd, it is possible to use proposed various methods.

In the single light emission profile data storage unit 104, single light emission profile data is recorded in advance. The single light emission profile data is profile data related to a reference single light emission distribution that is the distribution of the light emitted from the light-emitting unit 102 in the case where the light emission pattern of the light-emitting unit 102 is controlled to a reference single light emission pattern. The reference single light emission pattern is a light emission pattern in which a corresponding light source unit that is one of the plurality of the light source units emits light with a reference brightness, and all of the remaining light source units are turned off. The single light emission profile data is used for each of the plurality of the light source units. In the present embodiment, the single light emission profile data related to the brightness distribution is recorded in advance in the single light emission profile data storage unit 104. As the single light emission profile data storage unit 104, it is possible to use a magnetic disk, an optical disk, and a semiconductor memory. The single light emission profile data storage unit 104 may be incorporated in the apparatus (the display apparatus, the light-emitting apparatus, or the information processing apparatus), or may be detachable from the apparatus.

In the present embodiment, the single light emission profile data shows a brightness F that is normalized such that the maximum value is 1 for each of the plurality of the divided display areas. FIG. 5 shows an example of the distribution of the brightness F. FIG. 5 shows an example in which the light source unit corresponding to the divided display area in the second row and the second column is the corresponding light source unit. Light emitted from the light source unit attenuates with distance from the light source unit. Accordingly, in FIG. 5, the brightness F is maximized in the divided display area in the second row and the second column. The brightness F is reduced with distance from the divided display area in the second row and the second column. In the present embodiment, in the case where the light source unit corresponding to the divided display area in the m-th row and the n-th column is the corresponding light source unit, the brightness F of the divided display area in the m′-th row and the n′-th column is described as a “brightness Fmnm′n′”.

Note that a plurality of pieces of the single light emission profile data corresponding to the plurality of the light source units respectively may or may not be recorded in advance. The single light emission profile data corresponding to the light source unit is the single light emission profile data in the case where the light source unit is the corresponding light source unit. The number of pieces of the single light emission profile data may be smaller than the number of the light source units. For example, one piece of the single light emission profile data may be recorded in advance. Two or more pieces of the single light emission profile data that are smaller in number than the light source units may be recorded in advance. In the case where the number of pieces of the single light emission profile data is smaller than the number of the light source units, for example, one piece of the single light emission profile data serves as two or more pieces of the single light emission profile data corresponding to two or more light source units respectively. Even when the corresponding light source unit is changed among the plurality of the light source units, the shape of the reference single light emission distribution does not significantly change. Accordingly, it is possible to obtain two or more pieces of the single light emission profile data corresponding to two or more light source units respectively from one piece of the single light emission profile data by changing the position of one reference single light emission distribution. In addition, by turning on two or more light source units, one piece of the single light emission profile data having each of the two or more light source units as the corresponding light source unit may be generated. With this, it is possible to reduce the data size of the single light emission profile data.

The reference single light emission pattern is not limited to the above light emission pattern. For example, in the reference single light emission pattern, the light source unit that is far away from the corresponding light source unit may be turned on. The single light emission profile data is not limited to the profile data shown in FIG. 5. The single light emission profile data may be any data as long as the data relates to the reference single light emission distribution. The reference single light emission distribution is not limited to the brightness distribution. The reference single light emission distribution may include a color distribution. The reference single light emission distribution may include only one of the brightness distribution and the color distribution, and may also include both of the brightness distribution and the color distribution. The reference single light emission distribution may or may not include a plurality of distributions having mutually different value types. The reference single light emission distribution may be the distribution of XYZ tristimulus values, the distribution of the RGB values, or the distribution of YCbCr values. The reference brightness may or may not be the upper limit brightness of the light source unit.

In the peripheral light emission profile data storage unit 105, peripheral light emission profile data is recorded in advance. The peripheral light emission profile data is profile data based on a measurement result of a reference peripheral light emission distribution that is the distribution of the light emitted from the light-emitting unit 102 in the case where the light emission pattern of the light-emitting unit 102 is controlled to a reference peripheral light emission pattern. The reference peripheral light emission pattern is a light emission pattern in which the corresponding light source unit and a peripheral light source unit emit light with the reference brightness and all of the remaining light source units are turned off. The peripheral light emission profile data is used for each of the plurality of the light source units. The peripheral light source unit is the light source unit that is present in the periphery of the corresponding light source unit. In the present embodiment, the peripheral light emission profile data based on the measurement result of the brightness distribution is recorded in advance in the peripheral light emission profile data storage unit 105. As the peripheral light emission profile data storage unit 105, it is possible to use the magnetic disk, the optical disk, and the semiconductor memory. The peripheral light emission profile data storage unit 105 may be incorporated in the apparatus (the display apparatus, the light-emitting apparatus, or the information processing apparatus), or may be detachable from the apparatus. One storage unit serving as the single light emission profile data storage unit 104 and the peripheral light emission profile data storage unit 105 may or may not be used.

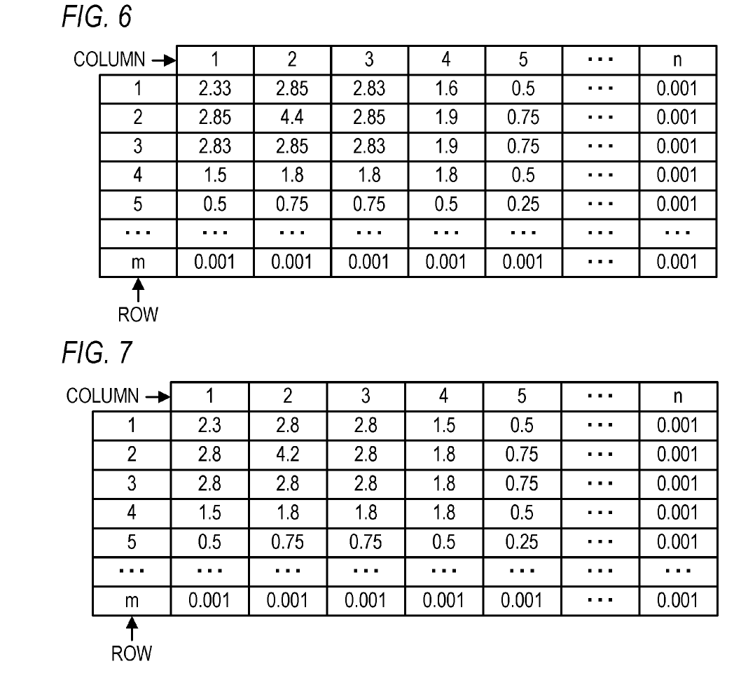

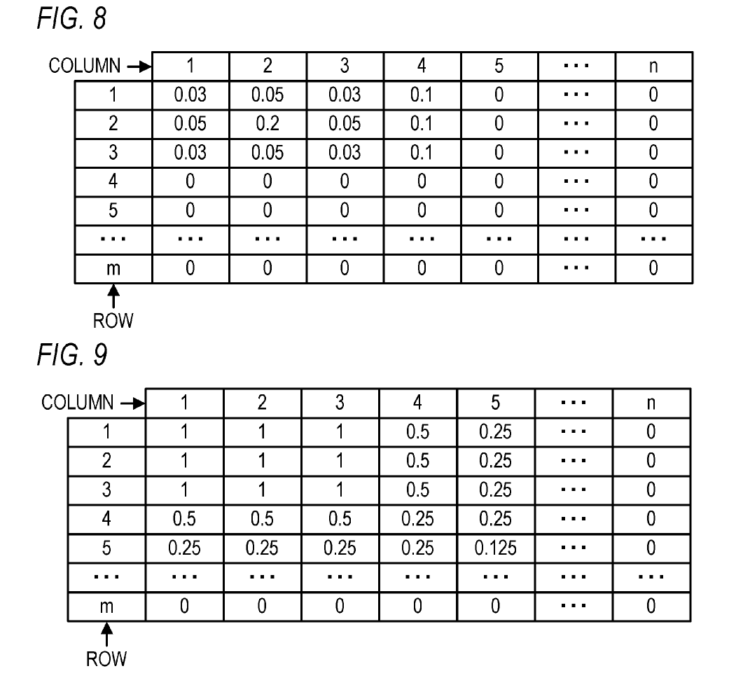

In the present embodiment, the peripheral light emission profile data is profile data that shows a difference (brightness difference) Fa between the reference peripheral light emission distribution estimated from the single light emission profile data in FIG. 5 and the measured reference peripheral light emission distribution. Each of FIGS. 6 to 8 shows an example in which the light source unit corresponding to the divided display area in the second row and the second column is the corresponding light source unit, and each of eight light source units adjacent to the corresponding light source unit is the peripheral light source unit. That is, each of FIGS. 6 to 8 shows an example of the case where only nine light source units from the first row and the first column to the third row and the third column emit light with the reference brightness. FIG. 6 shows the measured reference peripheral light emission distribution, FIG. 7 shows the estimated reference peripheral light emission distribution, and FIG. 8 shows the distribution of the brightness difference Fa.

It is possible to obtain the reference peripheral light emission distribution in FIG. 7 by combining nine reference single light emission distributions corresponding to the above nine light source units respectively. According to the single light emission profile data in FIG. 5, the brightness F of the divided display area corresponding to the corresponding light source unit is 1. The brightness F of each of four divided display areas adjacent to the divided display area corresponding to the corresponding light source unit in vertical and lateral directions is 0.5. The brightness F of each of four divided display areas adjacent to the divided display area corresponding to the corresponding light source unit in oblique directions is 0.3. Accordingly, with regard to the divided display area corresponding to the corresponding light source unit, 4.2 (=1+0.5×4+0.3×4) is obtained as the estimated value of the reference peripheral light emission distribution. Similarly, with regard to each of the other divided display areas, the estimated value of the reference peripheral light emission distribution is obtained. With this, the reference peripheral light emission distribution in FIG. 7 is obtained.

From FIGS. 6 and 7, it can be seen that the difference between the measured value of the reference peripheral light emission distribution and the estimated value of the reference peripheral light emission distribution occurs. The shape of the distribution of the light that is emitted from the light source unit and is then emitted from the light-emitting unit changes depending on the light emission pattern of the light-emitting unit, whereby the difference between the measured value of the reference peripheral light emission distribution and the estimated value of the reference peripheral light emission distribution occurs. The brightness difference Fa is a value obtained by subtracting the estimated value of the reference peripheral light emission distribution from the measured value of the reference peripheral light emission distribution. In the present embodiment, in the case where the light source unit corresponding to the divided display area in the m-th row and the n-th column is the corresponding light source unit, the brightness difference Fa of the divided display area in the m′-th row and the n′-th column is described as a “brightness difference Famnm′n′”.

Note that a plurality of pieces of the peripheral light emission profile data corresponding to the plurality of the light source units respectively may or may not be recorded in advance. The peripheral light emission profile data corresponding to the light source unit is the peripheral light emission profile data in the case where the light source unit is the corresponding light source unit. The number of pieces of the peripheral light emission profile data may be smaller than the number of the light source units. For example, one piece of the peripheral light emission profile data may be recorded in advance. Two or more pieces of the peripheral light emission profile data that are smaller in number than the light source units may be recorded in advance. In the case where the number of pieces of the peripheral light emission profile data is smaller than the number of the light source units, for example, one piece of the peripheral light emission profile data serves as two or more pieces of the peripheral light emission profile data corresponding to two or more light source units respectively. Even when the corresponding light source unit is changed among the plurality of the light source units, the shape of the reference peripheral light emission distribution does not significantly change. Accordingly, it is possible to obtain two or more pieces of the peripheral light emission profile data corresponding to two or more light source units respectively from one piece of the peripheral light emission profile data by changing the position of one reference peripheral light emission distribution. In addition, one piece of the peripheral light emission profile data having each of two or more light source units as the corresponding light source unit may be generated. With this, it is possible to reduce the data size of the peripheral light emission profile data.

In addition, the reference peripheral light emission pattern is not limited to the above light emission pattern. For example, in the reference peripheral light emission pattern, the light source unit that is far away from the corresponding light source unit may be turned on, and the corresponding light source unit may be turned off. The peripheral light source units are not limited to the above nine light source units. The number of the peripheral light source units may be more than or less than nine. A plurality of the peripheral light source units may include the light source unit that is not adjacent to the corresponding light source unit. The light source unit having a distance from the corresponding light source unit that is less than a threshold value may be used as the peripheral light source unit. The peripheral light emission profile data is not limited to the profile data shown in FIG. 8. The peripheral light emission profile data may be any data as long as the data is based on the measured reference peripheral light emission distribution. Data showing the measured reference peripheral light emission distribution may be used as the peripheral light emission profile data. In the case where the measured reference peripheral light emission distribution can be grasped from the peripheral light emission profile data, by the above calculation, it is possible to obtain the distribution of the brightness difference Fa. The ratio between the measured value of the reference peripheral light emission distribution and the estimated value of the reference peripheral light emission distribution may be used instead of the brightness difference Fa. The reference peripheral light emission distribution is not limited to the brightness distribution. The reference peripheral light emission distribution may include the color distribution. The reference peripheral light emission distribution may include only one of the brightness distribution and the color distribution, and may also include both of the brightness distribution and the color distribution. The reference peripheral light emission distribution may or may not include a plurality of distributions having mutually different value types.

In the present embodiment, the correction parameter (process parameter) for correcting the brightness of the input image data is generated based on a display light emission pattern, the single light emission profile data, and the peripheral light emission profile data. The display light emission pattern is a light emission pattern in which the light emission states of the plurality of the light source units are individually controlled based on the input image data. Note that the display light emission pattern is not limited to the above light emission pattern. For example, the display light emission pattern may also be a light emission pattern corresponding to an operation of a user performed on the apparatus (the display apparatus, the light-emitting apparatus, or the information processing apparatus). The correction parameter is not limited to the parameter for correcting the brightness of the input image data. The correction parameter may be any parameter as long as the parameter is used for correcting at least one of the input image data and the light emission pattern of the light-emitting unit. For example, the correction parameter may be a parameter for correcting the light emission brightness of each of the plurality of the light source units. The correction parameter may be a parameter for correcting the color of the input image data. The correction parameter may also be a parameter for correcting the luminescent color of each of the plurality of the light source units. The correction parameter may be a parameter for correcting any of the brightness of the input image data, the light emission brightness of each of the plurality of the light source units, the color of the input image data, and the luminescent color of each of the plurality of the light source units. The correction parameter may be a parameter for correcting two or more of the brightness of the input image data, the light emission brightness of each of the plurality of the light source units, the color of the input image data, and the luminescent color of each of the plurality of the light source units.

The single light emission profile data correction unit 106 acquires the single light emission profile data from the single light emission profile data storage unit 104, and acquires the peripheral light emission profile data from the peripheral light emission profile data storage unit 105. In addition, the single light emission profile data correction unit 106 acquires the light emission control value bd of each light source unit from the light emission state determination unit 103 as information on the light emission state corresponding to the display light emission pattern (display light emission state; corresponding light emission state). Subsequently, the single light emission profile data correction unit 106 corrects, for each of the plurality of the light source units, the single light emission profile data by using the light source unit as the corresponding light source unit based on the peripheral light emission profile data and the display light emission state (the light emission control value bd) of the peripheral light source unit. Hereinafter, the corrected single light emission profile data is described as “display light emission profile data”. By using the peripheral light emission profile data and the display light emission state of the peripheral light source unit, there is obtained the display light emission profile data in which the influence of light from the peripheral light source unit exerted on light emitted from the divided display area corresponding to the corresponding light source unit is considered. The display light emission profile data can be interpreted as “profile data related to a sub-single light emission distribution that is the distribution of the light emitted from the corresponding light source unit and then emitted from the light-emitting unit 102 and also the distribution having the shape corresponding to the display light emission pattern”.

Correction Method of Single Light Emission Profile Data

A description will be given of a specific example of a correction method of the single light emission profile data according to the present embodiment. Hereinbelow, a description will be given of a process that uses the light source unit corresponding to the divided display area in the m-th row and the n-th column as the corresponding light source unit. In the single light emission profile data correction unit 106, the following process is performed on each light source unit. Note that the following method is only exemplary, and the correction method of the single light emission profile data is not limited to the following method.

Step 2-1

First, the single light emission profile data correction unit 106 estimates an influence degree G based on the display light emission state of the peripheral light source unit. The influence degree G is the degree of the influence of the light from the peripheral light source unit exerted on the light emitted from the divided display area corresponding to the corresponding light source unit in the case where the light emission state of the peripheral light source unit is controlled to the display light emission state. In the present embodiment, the influence degree G of the light source unit corresponding to the divided display area in the m-th row and the n-th column is described as an “influence degree Gmn”. An estimation method of the influence degree Gmn is not particularly limited and, in the present embodiment, the single light emission profile data correction unit 106 calculates the influence degree Gmn by using the following Expression 3.

$$\begin{matrix} [ Math . 1 ] & \\ Gmn = \frac{{\sum }_{\{ i = m - 1 \text{\textasciitilde} m + 1 , j = n - 1 \text{\textasciitilde} n + 1 : i \neq m j \neq n \}}^{ } bdij}{the number of peripheral light source units} & ( Expression 3 )\end{matrix}$$

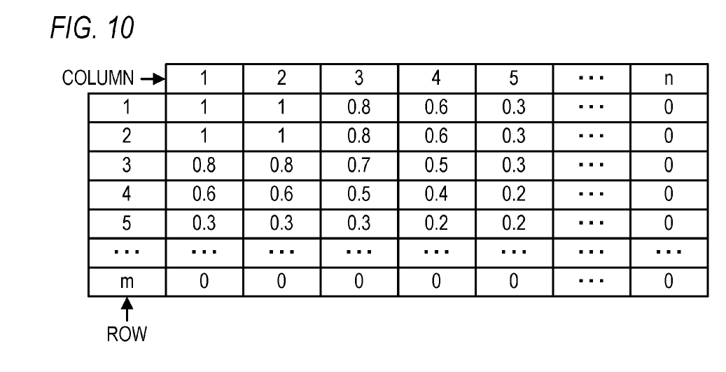

FIG. 9 shows an example of the distribution of the light emission control value bd, and FIG. 10 shows an example of the distribution of the influence degree G. In the case where a value shown in FIG. 9 is obtained as the light emission control value bd of each light source unit, a value shown in FIG. 10 is obtained as the influence degree G of each light source unit.

Step 2-2

Next, the single light emission profile data correction unit 106 corrects the single light emission profile data based on the peripheral light emission profile data and the influence degree G to generate the display light emission profile data. In the present embodiment, the sub-single light emission distribution is the brightness distribution, and the display light emission profile data shows a brightness P for each of the plurality of the divided display areas. In the present embodiment, in the case where the light source unit corresponding to the divided display area in the m-th row and the n-th column is the corresponding light source unit, the brightness P of the divided display area in the m′-th row and the n′-th column is described as a “brightness Pmnm′n′”. In the present embodiment, the single light emission profile data correction unit 106 calculates the brightness Pmnm′n′ by using the following Expression 4.

Pmnm′n′=Fmnm′n′+Famnm′n′×Gmn Expression 4

Note that the display light emission profile data is not limited to the above profile data. The display light emission profile data may be any data as long as the data relates to the sub-single light emission distribution. The sub-single light emission distribution is not limited to the brightness distribution. The sub-single light emission distribution may include the color distribution. The sub-single light emission distribution may include only one of the brightness distribution and the color distribution, and may also include both of the brightness distribution and the color distribution. The sub-single light emission distribution may or may not include a plurality of distributions having mutually different value types.

The display light emission distribution estimation unit 107 acquires the light emission control value bd of each light source unit as information on the display light emission pattern (display light emission state) from the light emission state determination unit 103, and acquires the display light emission profile data of each light source unit from the single light emission profile data correction unit 106. The display light emission distribution estimation unit 107 estimates a display light emission distribution based on the display light emission profile data (the brightness P) and the display light emission pattern (the light emission control value bd). The display light emission distribution is the distribution of the light emitted from the light-emitting unit 102 in the case where the light emission pattern of the light-emitting unit 102 is controlled to the display light emission pattern.

Estimation Method of Display Light Emission Distribution

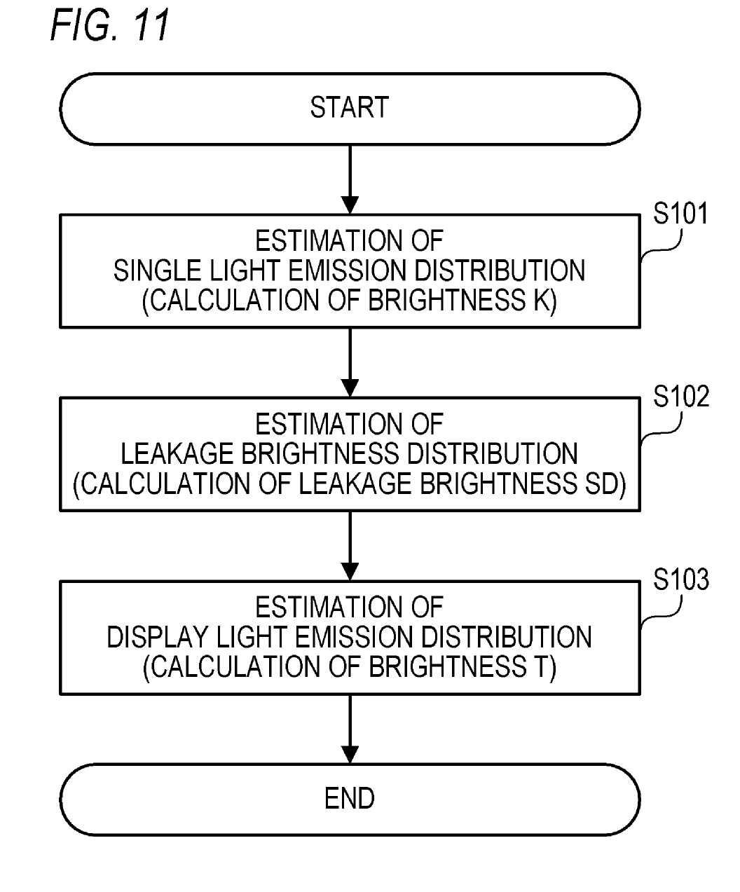

A description will be given of a specific example of an estimation method of the display light emission distribution according to the present embodiment by using a flowchart in FIG. 11. FIG. 11 is the flowchart showing the example of the estimation method of the display light emission distribution. Note that the following method is only exemplary, and the estimation method of the display light emission distribution is not limited to the following method.

First, in S101, the display light emission distribution estimation unit 107 estimates, for each of the plurality of the light source units, the single light emission distribution by using the light source unit as the corresponding light source unit based on the display light emission profile data and the display light emission state of the corresponding light source unit. The single light emission distribution is the distribution of the light emitted from the corresponding light source unit and then emitted from the light-emitting unit 102 in the case where the light emission pattern of the light-emitting unit 102 is controlled to the display light emission pattern. The single light emission distribution is different from the sub-single light emission distribution in that the display light emission state of the corresponding light source unit is considered in the single light emission distribution but the display light emission state of the corresponding light source unit is not considered in the sub-single light emission distribution. In the present embodiment, the single light emission distribution is the distribution of a brightness K (brightness distribution). In the present embodiment, in the case where the light source unit corresponding to the divided display area in the m-th row and the n-th column is the corresponding light source unit, the brightness K of the divided display area in the m′-th row and the n′-th column is described as a “brightness Kmnm′n′”. In the present embodiment, the display light emission distribution estimation unit 107 calculates the brightness Kmnm′n′ by using the following Expression 5.

Kmnm′n′=Pmnm′n′×BDmn Expression 5

“BDmn” in Expression 5 is the brightness corresponding to the light emission control value bdmn. For example, the brightness BDmn is the brightness of the light emitted from the light-emitting unit 102 in the case where the light emission state of the light source unit corresponding to the divided display area in the m-th row and the n-th column is controlled to the display light emission state and all of the remaining light source units are turned off. An acquisition method of the brightness BDmn is not particularly limited. For example, conversion information (a table, a function, or the like) indicative of a correspondence between the light emission control value bdmn and the brightness BDmn is prepared in advance, and the display light emission distribution estimation unit 107 converts the light emission control value bdmn to the brightness BDmn by using the conversion information.

Next, in S102 and S103, the display light emission distribution estimation unit 107 estimates the display light emission distribution by combining a plurality of the single light emission distributions corresponding to the plurality of the light source units respectively.

Specifically, in S102, the display light emission distribution estimation unit 107 estimates, for each of the plurality of the divided display areas, a brightness (leakage brightness) SD of light leaked from the other divided display areas based on the brightness K obtained in S101. In the present embodiment, the leakage brightness SD of the divided display area in the m-th row and the n-th column is described as a “leakage brightness SDmn”. In the present embodiment, the display light emission distribution estimation unit 107 calculates the leakage brightness SDmn by using the following Expression 6.

$$\begin{matrix}[ Math . 2 ] & \\ SDmn = {\sum }_{\{ {m}^{′} , {n}^{′} : {m}^{′} \neq m {n}^{′} \neq n \}}^{ } {Km}^{′} {n}^{′} mn & ( Expression 6 )\end{matrix}$$

Subsequently, in S103, the display light emission distribution estimation unit 107 estimates the display light emission distribution based on the brightness K obtained in S101 and the leakage brightness SD obtained in S102. In the present embodiment, the display light emission distribution is the distribution of a brightness T (brightness distribution). In the present embodiment, the brightness T of the divided display area in the m-th row and the n-th column is described as a “brightness Tmn”. In the present embodiment, the display light emission distribution estimation unit 107 calculates the brightness Tmn by using the following Expression 7. When the brightness Kmnmn is regarded as a reference, the brightness Tmn can be interpreted as the “degree of brightness change by the leakage light (brightness change degree)”.

Tmn=Kmnmn+SDmn Expression 7

Note that the single light emission distribution is not limited to the brightness distribution. The single light emission distribution may include the color distribution. The single light emission distribution may include only one of the brightness distribution and the color distribution, and may also include both of the brightness distribution and the color distribution. The single light emission distribution may or may not include a plurality of distributions having mutually different value types. The same applies to the display light emission distribution.

The correction parameter generation unit 108 generates a correction parameter U for correcting the brightness of the input image data based on the display light emission distribution estimated by the display light emission distribution estimation unit 107. In the present embodiment, a parameter for suppressing the change of a display brightness (the brightness of the display image) caused by the change of the brightness of the light emitted from the light-emitting unit 102 from a correction reference brightness BLYt is generated as the correction parameter U. The correction reference brightness BLYt is, e.g., the brightness of the light emitted from the light-emitting unit 102 in the case where the local dimming control is not performed.

Generation Method of Correction Parameter

A description will be given of a specific example of a generation method of the correction parameter according to the present embodiment. In the present embodiment, the correction parameter generation unit 108 generates, for each of the plurality of the divided display areas, a gain value by which the pixel value of the input image data is multiplied as the correction parameter U based on the correction reference brightness BLYt and the brightness T. In the present embodiment, the correction parameter U of the divided display area in the m-th row and the n-th column is described as a “correction parameter Umn”. In the present embodiment, the correction parameter generation unit 108 calculates the correction parameter Umn by using the following Expression 8.

Umn=BLYt÷Tmn Expression 8

According to Expression 8, in the case where the brightness Tmn is lower than the correction reference brightness BLYt, the correction parameter Umn for increasing the brightness of the input image data is calculated. On the other hand, in the case where the brightness Tmn is higher than the correction reference brightness BLYt, the correction parameter Umn for reducing the brightness of the input image data is calculated.

Note that the area for which the correction parameter is generated (parameter generation area) is not limited to the divided display area. The number of the parameter generation areas may be more than or less than the number of the divided display areas. The size of the parameter generation area may correspond to the size of one pixel or may also correspond to the size of a plurality of pixels. By combining a plurality of the brightnesses T corresponding to the plurality of the divided display areas, it is possible to obtain the brightness T of the parameter generation area different from the divided display area. Similarly, by combining a plurality of the correction parameters U corresponding to the plurality of the divided display areas, it is possible to obtain the correction parameter U of the parameter generation area different from the divided display area. Herein, consideration is given to the case where the brightness T is the brightness at a predetermined position (a center position or the like) in the divided display area. In this case, by performing interpolation that uses a plurality of the brightnesses T corresponding to the plurality of the divided display areas, it is possible to obtain the brightness T at a position other than the predetermined position. Similarly, by performing interpolation that uses a plurality of the correction parameters U corresponding to the plurality of the divided display areas, it is possible to obtain the correction parameter U at a position other than the predetermined position.

Note that the correction parameter U is not limited to the above gain value. For example, an offset value that is added to the pixel value of the input mage data may be generated as the correction parameter U. The correction reference brightness is not limited to the above brightness. The correction reference brightness may also be the brightness of the light emitted from the light-emitting unit 102 in the case where the light emission brightness of each light source unit is controlled to the upper limit brightness. The correction reference brightness may be changed in accordance with the input image data. The correction reference brightness may differ among a plurality of the parameter generation areas.

Note that the generation method of the correction parameter is not limited to the above method. In the above method, a plurality of pieces of intermediate data are generated when the correction parameter is obtained from the display light emission pattern, the single light emission profile data, and the peripheral light emission profile data. However, at least any of the plurality of pieces of intermediate data may not be generated. For example, without generating the display light emission profile data, the single light emission distribution may be estimated directly from the single light emission profile data, the peripheral light emission profile data, the display light emission state of the corresponding light source unit, and the display light emission state of the peripheral light source unit. Without generating the display light emission profile data and without estimating the single light emission distribution, the display light emission distribution may be estimated directly from the display light emission pattern, the single light emission profile data, and the peripheral light emission profile data. Without estimating the display light emission distribution, the correction parameter may be generated directly from the display light emission pattern and the display light emission profile data. Without generating the display light emission profile data and without estimating the display light emission distribution, the correction parameter may be generated directly from the display light emission pattern, the single light emission profile data, and the peripheral light emission profile data.

The image processing unit 109 generates the display image data by correcting the input image data based on the correction parameter generated by the correction parameter generation unit 108. In the present embodiment, the image processing unit 109 multiplies, for each of the plurality of the divided display areas, each pixel value of the input image data in the divided display area by the correction parameter U of the divided display area. Subsequently, the image processing unit 109 outputs the display image data to the display unit 101.

Effect

As described thus far, according to the present embodiment, as the profile data, not only the single light emission profile data but also the peripheral light emission profile data is used. With this, as the process parameter (correction parameter) used in the process based on the distribution of the light emitted from the light-emitting apparatus (light-emitting unit), it is possible to obtain the process parameter that realizes the high-accuracy process. Specifically, it is possible to obtain the process parameter set by considering that the shape of the distribution of the light emitted from the light source unit and then emitted from the light-emitting apparatus changes depending on the light emission pattern of the light-emitting apparatus. By extension, it is possible to correct the input image data and the light emission pattern with high accuracy, and it is possible to control the distribution of the light from the light-emitting apparatus to a desired distribution and improve the quality of the display image. Specifically, it is possible to suppress unintentional brightness unevenness of the light from the light-emitting apparatus, unintentional color unevenness of the light from the light-emitting apparatus, brightness deviation of the light from the light-emitting apparatus, and color shift of the light from the light-emitting apparatus with high accuracy. It is also possible to suppress the brightness unevenness of the display image, the color unevenness of the display image, the brightness deviation of the display image, and the color shift of the display image with high accuracy.

### Embodiment 2

Hereinbelow, Embodiment 2 of the present invention will be described. Embodiment 1 has described the example in which the correction parameter for correcting the brightness of the input image data is generated. In the present embodiment, a description will be give of an example in which the corrosion parameter for correcting the luminescent color of each light source unit is further generated. Note that, as described in Embodiment 1, the correction parameter may be any parameter as long as the parameter is used for correcting at least one of the input image data and the light emission pattern of the light-emitting unit. Hereinbelow, points different from those in Embodiment 1 (the configuration, the process, and the like) will be described in detail and the description of points similar to those in Embodiment 1 will be omitted.

Configuration of Display Apparatus

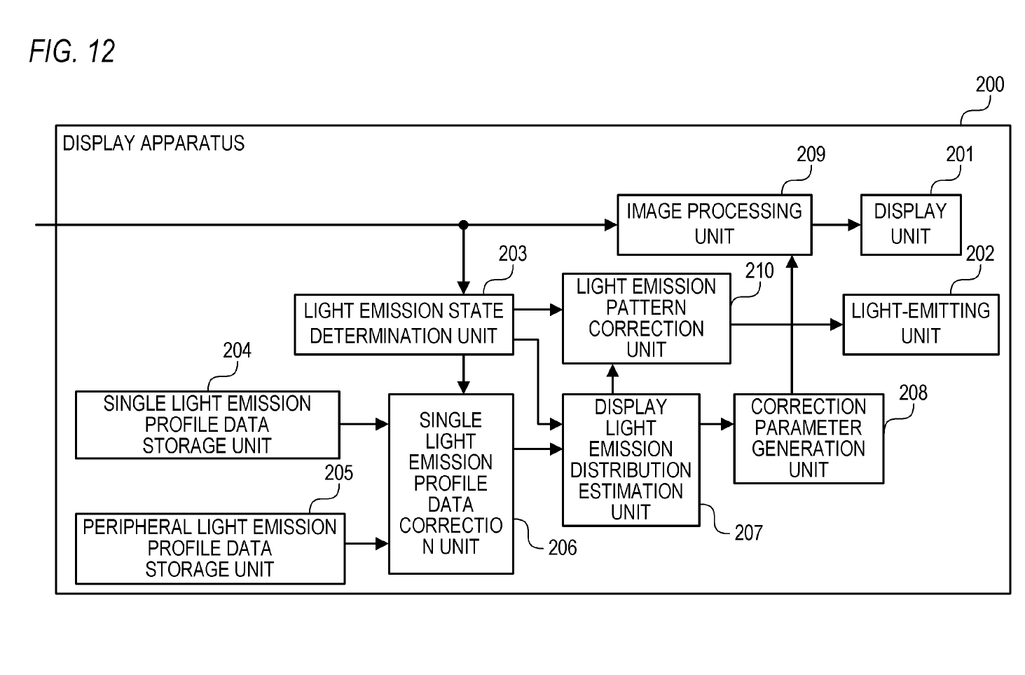

A description will be given of an example of the configuration of a display apparatus according to the present embodiment. FIG. 12 shows the example of the configuration of a display apparatus 200 according to the present embodiment. The display apparatus 200 has a display unit 201, a light-emitting unit 202, a light emission state determination unit 203, a single light emission profile data storage unit 204, and a peripheral light emission profile data storage unit 205. In addition, the display apparatus 200 has a single light emission profile data correction unit 206, a display light emission distribution estimation unit 207, a correction parameter generation unit 208, an image processing unit 209, and a light emission pattern correction unit 210.

The display unit 201 has the same function as that of the display unit 101 in Embodiment 1. The light-emitting unit 202 has the same function as that of the light-emitting unit 102 in Embodiment 1. However, in the present embodiment, each of a plurality of the light source units of the light-emitting unit 202 has a configuration capable of changing the luminescent color. Specifically, the light-emitting unit 202 does not have the conversion member, and each of the plurality of the light source units has one or more LEDs that emit red light (R-LED), one or more LEDs that emit green light (G-LED), and one or more LEDs that emit blue light (B-LED). The luminescent color of the light source unit can be changed by changing the ratio of the light emission brightness of the R-LED, the light emission brightness of the G-LED, and the light emission brightness of the B-LED.

Note that the configuration of the light source unit is not particularly limited. As the light-emitting element, at least any of the three types of the LEDs described above may not be used, and another LED may be used. For example, the LED that emits yellow light may be used. As the configuration of the light source unit capable of changing the luminescent color, it is possible to use proposed various methods.

The light emission state determination unit 203 has the same function as that of the light emission state determination unit 103 in Embodiment 1. However, in the present embodiment, the light emission control value of the R-LED, the light emission control value of the G-LED, and the light emission control value of the B-LED are determined for each of the plurality of the light source units such that a predetermined color (e.g., white) can be obtained as the luminescent color. Specifically, by the same method as that in Embodiment 1, the light emission control value bd is calculated as each of the light emission control values of the R-LED, the G-LED, and the B-LED. Note that a determination method of the light emission control value is not particularly limited. For example, the luminescent color of the light source unit may be determined based on the color of the input image data.

Similarly to the single light emission profile data storage unit 104 in Embodiment 1, in the single light emission profile data storage unit 204, the single light emission profile data is recorded in advance. However, in the present embodiment, the single light emission profile data related to both of the brightness distribution and the color distribution is recorded in advance in the single light emission profile data storage unit 204. Specifically, the profile data related to the distribution of XYZ tristimulus values is recorded as the single light emission profile data. More specifically, single X profile data related to the distribution of an X value, single Y profile data related to the distribution of a Y value, and single Z profile data related to the distribution of a Z value are recorded as the single light emission profile data. In this case, the combination of the distribution of the X value and the distribution of the Z value corresponds to the color distribution. Note that, as described in Embodiment 1, the single light emission profile data, the reference single light emission distribution, and the reference single light emission pattern are not particularly limited.

In the present embodiment, the single X profile data shows an X value FX for each of a plurality of the divided display areas. The single Y profile data shows a Y value FY for each of the plurality of the divided display areas. The single Z profile data shows a Z value FZ for each of the plurality of the divided display areas. In the present embodiment, in the case where the light source unit corresponding to the divided display area in the m-th row and the n-th column is the corresponding light source unit, the X value FX of the divided display area in the m′-th row and the n′-column is described as a “brightness FXmnm′n′”. The Y value FY of the divided display area in the m′-th row and the n′-column is described as a “brightness FYmnm′n′”. The Z value FZ of the divided display area in the m′-th row and the n′-column is described as a “brightness FZmnm′n′”.

Similarly to the peripheral light emission profile data storage unit 105 in Embodiment 1, in the peripheral light emission profile data storage unit 205, the peripheral light emission profile data is recorded in advance. However, in the present embodiment, the peripheral light emission profile data based on the measurement result of the distribution including the brightness distribution and the color distribution is recorded in advance in the peripheral light emission profile data storage unit 205. Specifically, the profile data based on the measurement result of the distribution of the XYZ tristimulus values is recorded as the peripheral light emission profile data. More specifically, peripheral X profile data based on the measurement result of the distribution of the X value, peripheral Y profile data based on the measurement result of the distribution of the Y value, and peripheral Z profile data based on the measurement result of the distribution of the Z value are recorded as the peripheral light emission profile data. Note that, as described in Embodiment 1, the peripheral light emission profile data, the reference peripheral light emission distribution, and the reference peripheral light emission pattern are not particularly limited.

In the present embodiment, the peripheral X profile data shows an X difference (a difference between the estimated X value and the measured X value) FaX for each of the plurality of the divided display areas. The peripheral Y profile data shows a Y difference (a difference between the estimated Y value and the measured Y value) FaY for each of the plurality of the divided display areas. The peripheral Z profile data shows a Z difference (a difference between the estimated Z value and the measured Z value) FaZ for each of the plurality of the divided display areas. In the present embodiment, in the case where the light source unit corresponding to the divided display area in the m-th row and the n-th column is the corresponding light source unit, the X difference FaX of the divided display area in the m′-th row and the n′-th column is described as an “X difference FaXmnm′n′”. The Y difference FaY of the divided display area in the m′-th row and the n′-th column is described as a “Y difference FaYmnm′n′”. The Z difference FaZ of the divided display area in the m′-th row and the n′-th column is described as a “Z difference FaZmnm′n′”.

The single light emission profile data correction unit 206 has the same function as that of the single light emission profile data correction unit 106 in Embodiment 1. However, in the present embodiment, the display light emission profile data related to both of the brightness distribution and the color distribution is generated. Specifically, each of the following three pieces of the profile data is generated as the display light emission profile data. Note that, as described in Embodiment 1, the display light emission profile data and the sub-single light emission distribution are not particularly limited.

brightness profile data that shows the brightness P for each of the plurality of the divided display areas

brightness profile data that shows an X value PX for each of the plurality of the divided display areas

brightness profile data that shows a Z value PZ for each of the plurality of the divided display areas

The brightness P is calculated by the same method as that in Embodiment 1. The brightness F corresponding to the single light emission profile data can be calculated from the XYZ tristimulus values (the X value, the Y value, the Z value)=(FX, FY, FZ), and the brightness difference Fa corresponding to the peripheral light emission profile data can be calculated from the differences of the XYZ tristimulus values (FaX, FaY, FaZ). Note that the Y value may be used instead of the brightness P.

In the present embodiment, in the case where the light source unit corresponding to the divided display area in the m-th row and the n-th column is the corresponding light source unit, the X value PX of the divided display area in the m′-th row and the n′-th column is described as an “X value PXmnm′n′”, and the Z value PZ of the divided display area in the m′-th row and the n′-th column is described as a “Z value PZmnm′n′”. In the present embodiment, the single light emission profile data correction unit 206 calculates the X value PXmnm′n′ and the Z value PZmnm′n′ by using the following Expressions 9 and 10.

PXmnm′n′=FXmnm′n′+FXamnm′n′×Gmn Expression 9

PZmnm′n′=FZmnm′n′+FZamnm′n′×Gmn Expression 10

The display light emission distribution estimation unit 207 has the same function as that of the display light emission distribution estimation unit 107 in Embodiment 1. However, in the present embodiment, the single light emission distribution related to both of the brightness distribution and the color distribution is estimated, and the display light emission distribution related to both of the brightness distribution and the color distribution is estimated. Specifically, each of the distribution of the brightness K, the distribution of an X value KX, and the distribution of a Z value KZ is estimated as the single light emission distribution. Each of the distribution of the brightness T, the distribution of an X value CX, and the distribution of a Z value CZ is estimated as the display light emission distribution. Note that, as described in Embodiment 1, the single light emission distribution and the display light emission distribution are not particularly limited.

Estimation Method of Display Light Emission Distribution

A description will be given of a specific example of the estimation method of the display light emission distribution according to the present embodiment. Note that the following method is only exemplary, and the estimation method of the display light emission distribution is not limited to the following method. Each of the brightnesses K and T is calculated by the same method as that in Embodiment 1.

Step 3-1

First, the display light emission distribution estimation unit 207 estimates, for each of the plurality of the light source units, the distribution of the X value KX and the distribution of the Z value KZ by using the light source unit as the corresponding light source unit. In the present embodiment, in the case where the light source unit corresponding to the divided display area in the m-th row and the n-th column is the corresponding light source unit, the X value KX of the divided display area in the m′-th row and the n′-th column is described as an “X value KXmnm′n′”, and the Z value KZ of the divided display area in the m′-th row and the n′-th column is described as a “Z value KZmnm′n′”. In the present embodiment, the display light emission distribution estimation unit 207 calculates the X value KXmnm′n′ and the Z value KZmnm′n′ by using the following Expressions 11 and 12.

KXmnm′n′=PXmnm′n′×BDmn Expression 11

KZmnm′n′=PZmnm′n′×BDmn Expression 12

Step 3-2

Next, the display light emission distribution estimation unit 207 estimates, for each of the plurality of the divided display areas, an X value (leakage X value) SX of light leaked from the other divided display areas based on the X value KX. In addition, the display light emission distribution estimation unit 207 estimates, for each of the plurality of the divided display areas, a Z value (leakage Z value) SZ of the light leaked from the other divided display areas based on the Z value KZ. In the present embodiment, the leakage X value SX of the divided display area in the m-th row and the n-th column is described as a “leakage X value SXmn”, and the leakage Z value SZ of the divided display area in the m-th row and the n-th column is described as a “leakage Z value SZmn”. In the present embodiment, the display light emission distribution estimation unit 207 calculates the leakage X value SXmn and the leakage Z value SZmn by using the following Expressions 13 and 14.

$$\begin{matrix}[ Math . 3 ] & \\ SXmn = {\sum }_{\{ {m}^{′} , {n}^{′} : {m}^{′} \neq m {n}^{′} \neq n \}}^{ } {KXm}^{′} {n}^{′} mn & ( Expression 13 ) \\ SZmn = {\sum }_{\{ {m}^{′} , {n}^{′} : {m}^{′} \neq m {n}^{′} \neq n \}}^{ } {KZm}^{′} {n}^{′} mn & ( Expression 14 )\end{matrix}$$

Step 3-3

Subsequently, the display light emission distribution estimation unit 207 estimates the distribution of the X value CX and the distribution of the Z value CZ based on the X value KX, the Z value KZ, the leakage X value SX, and the leakage Z value SZ. In the present embodiment, the X value CX of the divided display area in the m-th row and the n-th column is described as an “X value CXmn”, and the Z value CZ of the divided display area in the m-th row and the n-th column is described as a “Z value CZmn”. In the present embodiment, the display light emission distribution estimation unit 207 calculates the X value CXmn and the Z value CZmn by using the following Expressions 15 and 16. When the X value KXmnmn is regarded as a reference, the X value CXmn can be interpreted as the “degree of change of the X value by the leakage light (color change degree)”. Similarly, when the Z value KZmnmn is regarded as a reference, the Z value CZmn can be interpreted as the “degree of change of the Z value by the leakage light (color change degree)”.

CXmn=KXmnmn+SXmn Expression 15

CZmn=KZmnmn+SZmn Expression 16

The correction parameter generation unit 208 has the same function as that of the correction parameter generation unit 108 in Embodiment 1, and the image processing unit 209 has the same function as that of the image processing unit 109 in Embodiment 1.

The light emission pattern correction unit 210 generates correction parameters (light emission correction parameters) WR, WG, and WB for correcting the light emission pattern of the light-emitting unit 202 based on the display light emission distribution estimated by the display light emission distribution estimation unit 207. In the present embodiment, parameters for suppressing the change of the XYZ tristimulus values of the light emitted from the light-emitting unit 202 from correction reference XYZ tristimulus values (BLXu, BLYu, BLZu) are generated as the light emission correction parameters WR, WG, and WB. The correction reference XYZ tristimulus values (BLXu, BLYu, BLZu) are, e.g., the XYZ tristimulus values of the light emitted from the light-emitting unit 202 in the case where the local dimming control is not performed.

Generation Method of Light Emission Correction Parameter

A description will be given of a specific example of a generation method of the light emission correction parameter according to the present embodiment. In the present embodiment, the light emission pattern correction unit 210 generates the light emission correction parameters WR, WG, and WB for each of the plurality of the light source units (the plurality of the divided display areas). In the present embodiment, the light emission correction parameters WR, WG, and WB are generated based on the correction reference XYZ tristimulus values (BLXu, BLYu, BLZu), the X value CX, and the Z value CZ. In the present embodiment, the light emission correction parameter WR is a gain value by which the light emission control value bd of the R-LED is multiplied. The light emission correction parameter WG is a gain value by which the light emission control value bd of the G-LED is multiplied. The light emission correction parameter WB is a gain value by which the light emission control value bd of the B-LED is multiplied.

Step 4-1

First, the light emission pattern correction unit 210 calculates XYZ tristimulus values (tmpX, tmpY, tmpZ) normalized with BLYu/Tu for each of the plurality of the light source units by using the following Expressions 17 to 19.

tmpX=(BLXu÷BLYu)÷(CX÷T) Expression 17

tmpY=BLYu÷BLYu=1 Expression 18

tmpZ=(BLZu÷BLYu)÷(CZ÷T) Expression 19

Step 4-2

Next, the light emission pattern correction unit 210 converts the XYZ tristimulus values (tmpX, tmpY, tmpZ) to the light emission correction parameters (WR, WG, WB). In the present embodiment, the light emission pattern correction unit 210 converts the XYZ tristimulus values (tmpX, tmpY, tmpZ) to the light emission correction parameters (WR, WG, WB) by using the following Expression 20. Elements aX, aY, aZ, bX, bY, bZ, cX, cY, and cZ in a conversion matrix in Expression 20 are coefficients for converting the XYZ tristimulus values to the light emission brightness of each LED, and are prepared in advance.

$$\begin{matrix}[ Math . 4 ] & \\ ( \begin{matrix}WR \\ WG \\ WB\end{matrix} ) = ( \begin{matrix}aX & aY & aZ \\ bX & bY & bZ \\ cX & cY & cZ\end{matrix} ) ( \begin{matrix}tempX \\ tempY \\ tempZ\end{matrix} ) & ( Expression 20 )\end{matrix}$$

Note that the light emission correction parameter is not limited to the above gain value. For example, an offset value that is added to the light emission control value bd may be generated as the light emission correction parameter. The correction reference XYZ tristimulus values are not limited to the above XYZ tristimulus values. The correction reference XYZ tristimulus values may also be the XYZ tristimulus values of the light emitted from the light source unit in the case where the light emission brightness of each LED is controlled to the upper limit brightness. The correction reference XYZ tristimulus values may be changed in accordance with the input image data. The correction reference XYZ tristimulus values may differ among the plurality of the light source units.

Note that the generation method of the light emission correction parameter is not limited to the above method. In the above method, a plurality of pieces of intermediate data are generated when the light emission correction parameter is obtained from the display light emission pattern, the single light emission profile data, and the peripheral light emission profile data. However, at least any of the plurality of pieces of intermediate data may not be generated.

The light emission pattern correction unit 210 corrects the light emission pattern of the light-emitting unit 202 by using the generated correction parameters. In the present embodiment, the light emission pattern correction unit 210 multiplies the light emission control value bd of the R-LED by the light emission correction parameter WR, multiplies the light emission control value bd of the G-LED by the light emission correction parameter WG, and multiplies the light emission control value bd of the B-LED by the light emission correction parameter WB. The light emission pattern correction unit 210 performs this process for each of the plurality of the divided display areas. Subsequently, the light emission pattern correction unit 210 outputs each light emission control value bd that is corrected to the light-emitting unit 202.

Effect

As described thus far, in the present embodiment as well, as the profile data, not only the single light emission profile data but also the peripheral light emission profile data is used. With this, as the process parameter (correction parameter) that is used in the process based on the distribution of the light emitted from the light-emitting apparatus (light-emitting unit), it is possible to obtain the process parameter that realizes the high-accuracy process. Specifically, it is possible to correct the brightness of the display image with high accuracy in Embodiment 1, while it is possible to further correct the luminescent color of the light-emitting unit and the color of the display image with high accuracy in the present embodiment.

Note that each functional unit in Embodiments 1 and 2 may or may not be individual hardware. Functions of two or more functional units may be implemented by common hardware. Each of a plurality of functions of one functional unit may be implemented by individual hardware. Two or more functions of one functional unit may be implemented by common hardware. In addition, each functional unit may or may not be implemented by hardware. For example, an apparatus may have a processor and a memory in which a control program is stored. A function of at least part of functional units of the apparatus may be implemented by reading the control program from the memory and executing the control program by the processor.

Note that Embodiments 1 and 2 are only exemplary, and a configuration obtained by appropriately modifying or changing the configurations of Embodiments 1 and 2 without departing from the gist of the present invention is also included in the present invention. A configuration obtained by appropriately combining the configurations of Embodiments 1 and 2 is also included in the present invention. For example, the light-emitting unit having the conversion member may be used in Embodiment 2.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-237330, filed on Dec. 7, 2016, which is hereby incorporated by reference herein in its entirety.

What is claimed is:

1. An information processing apparatus comprising:
at least one processor; and
at least one memory storing a program which, when executed by the at least one processor, causes the information processing apparatus to
acquire first profile data related to a first distribution that is a distribution of light emitted from a light-emitting unit of a display apparatus in a first light emission pattern in which one light source unit that is one of a plurality of light source units of the light-emitting unit emits light;
acquire second profile data related to a second distribution that is a distribution of light emitted from the light-emitting unit in a second light emission pattern in which two or more peripheral light source units that are present in a periphery of the one light source unit emit light; and
generate, based on a third light emission pattern that is different from the first light emission pattern and the second light emission pattern and is based on input image data of the display apparatus, the first profile data, and the second profile data, a correction parameter for correcting at least one of the input image data and the third light emission pattern.

2. The information processing apparatus according to claim 1, wherein
a light emission state of each of the plurality of light source units is individually controlled based on the input image data, and
the third light emission pattern is a light emission pattern in which the light emission state of each of the plurality of light source units is individually controlled based on the input image data.

3. The information processing apparatus according to claim 1, wherein
the light-emitting unit further has a conversion member configured to convert a wavelength of light emitted from the plurality of light source units.

4. The information processing apparatus according to claim 3, wherein
the conversion member has a quantum dot configured to convert the wavelength of the light emitted from the plurality of light source units.

5. The information processing apparatus according to claim 3, wherein
each of the plurality of light source units has one or more light-emitting elements configured to emit predetermined light, and
the conversion member converts a wavelength of the predetermined light.

6. The information processing apparatus according to claim 5, wherein
each of the plurality of light source units has, as the one or more light-emitting elements configured to emit the predetermined light, at least one or more light-emitting elements configured to emit blue light or one or more light-emitting elements configured to emit ultraviolet light.

7. The information processing apparatus according to claim 1, wherein
each of the plurality of light source units has one or more light-emitting elements configured to emit white light.

8. The information processing apparatus according to claim 1, wherein
each of the plurality of light source units has a plurality of light-emitting elements of which luminescent colors are different from each other.

9. The information processing apparatus according to claim 8, wherein
each of the plurality of light source units has one or more light-emitting elements configured to emit red light, one or more light-emitting elements configured to emit green light, and one or more light-emitting elements configured to emit blue light.

10. The information processing apparatus according to claim 1, wherein
the second profile data shows a difference between a second distribution estimated from the first profile data and a measured second distribution.

11. The information processing apparatus according to claim 1, wherein
each of the first distribution and the second distribution includes a brightness distribution, and
the correction parameter is a parameter for correcting at least one of brightness of the input image data and light emission brightness of each of the plurality of light source units.

12. The information processing apparatus according to claim 1, wherein
each of the first distribution and the second distribution includes a color distribution, and
the correction parameter is a parameter for correcting at least one of a color of the input image data and a luminescent color of each of the plurality of light source units.

13. The information processing apparatus according to claim 12, wherein
each of the first distribution and the second distribution includes, as the color distribution, a distribution of an X value of XYZ tristimulus values and a distribution of a Z value of the XYZ tristimulus values.

14. The information processing apparatus according to claim 1, wherein
for each of the plurality of light source units, by using the light source unit as the one light source unit, the first profile data is corrected based on the second profile data and a corresponding light emission state of each of the peripheral light source units corresponding to the third light emission pattern, and
the correction parameter is generated based on a plurality of pieces of the corrected first profile data corresponding to the plurality of light source units respectively and the third light emission pattern.

15. The information processing apparatus according to claim 14, wherein
a light-emitting surface of the light-emitting unit has a plurality of partial areas corresponding to the plurality of light source units respectively, and
a degree is estimated based on the corresponding light emission state of the peripheral light source unit, the degree being a degree of an influence of light from the peripheral light source unit exerted on light emitted from one of the plurality of partial areas which corresponds to the one light source unit in a case where a light emission state of the peripheral light source unit is controlled to the corresponding light emission state, and
the first profile data is corrected based on the second profile data and the degree of the influence.

16. The information processing apparatus according to claim 1, wherein
a third distribution is estimated based on the first profile data, the second profile data, and the third light emission pattern, the third distribution being a distribution of light emitted from the light-emitting unit in a case where the light emission pattern is controlled to the third light emission pattern, and
the correction parameter is generated based on the third distribution.

17. The information processing apparatus according to claim 16, wherein
for each of the plurality of light source units, by using the light source unit as the one light source unit, a fourth distribution is estimated based on the first profile data, the second profile data, a corresponding light emission state of the one light source unit, and a corresponding light emission state of each of the peripheral light source units, the fourth distribution being a distribution of light that is emitted from the one light source unit and then emitted from the light-emitting unit in a case where the light emission pattern is controlled to the third light emission pattern, and
the third distribution is estimated by combining a plurality of fourth distributions corresponding to the plurality of light source units respectively.

18. The information processing apparatus according to claim 1, wherein the information processing apparatus is the display apparatus.

19. An information processing method comprising:
acquiring first profile data related to a first distribution that is a distribution of light emitted from a light-emitting unit of a display apparatus in a first light emission pattern in which one light source unit that is one of a plurality of light source units of the light-emitting unit emits light;
acquiring second profile data related to a second distribution that is a distribution of light emitted from the light-emitting unit in a second light emission pattern in which two or more peripheral light source units that are present in a periphery of the one light source unit emit light; and
generating, based on a third light emission pattern that is different from the first light emission pattern and the second light emission pattern and is based on input image data of the display apparatus, the first profile data, and the second profile data, a correction parameter for correcting at least one of the input image data and the third light emission pattern.

20. A non-transitory computer readable medium that stores a program, wherein
the program causes a computer to execute:
acquiring first profile data related to a first distribution that is a distribution of light emitted from a light-emitting unit of a display apparatus in a first light emission pattern in which one light source unit that is one of a plurality of light source units of the light-emitting unit emits light;
acquiring second profile data related to a second distribution that is a distribution of light emitted from the light-emitting unit in a second light emission pattern in which two or more peripheral light source units that are present in a periphery of the one light source unit emit light; and
generating, based on a third light emission pattern that is different from the first light emission pattern and the second light emission pattern and is based on input image data of the display apparatus, the first profile data, and the second profile data, a correction parameter for correcting at least one of the input image data and the third light emission pattern.
